(19) United States
(12) Patent Application Publication
(10) Pub. No.: US 2017/0191541 A1
(43) Pub. Date: Jul. 6, 2017

(54) TRUCK BRAKE COOLING SYSTEM

(71) Applicant: Ray Fleet, Red oak, TX (US)

(72) Inventor: Ray Fleet, Red oak, TX (US)

(21) Appl. No.: 15/393,989

(22) Filed: Dec. 29, 2016

Related U.S. Application Data
(60) Provisional application No. 62/273,581, filed on Dec. 31, 2015.

(51) Int. Cl. F16D 65/827; F16D 65/78

(52) U.S. Cl. CPC F16D 65/827; F16D 65/78; F16D 2065/787; F16D 2065/783

(57) ABSTRACT

A brake cooling system for a heavy-duty truck includes an air compressor mounted on a truck-cab chassis that is in fluid communication with a pressurized air reservoir. The reservoir outlet includes an automatic solenoid valve that establishes select communication between the reservoir and an air distribution system. The air distribution system is formed of a network of compressed air tubes having arteries that each extend to a designated brake drum. Whenever the vehicle is traveling above a predetermined speed and the brake pedal is applied, a microprocessor opens the solenoid to deliver cooling air to each brake drum.

### BACKGROUND OF THE INVENTION

The present invention relates to a cooling system that improves the reliability and operating efficiency of the brakes on a commercial truck.

### DESCRIPTION OF THE PRIOR ART

Commercial trucks and similar heavy-duty vehicles are often hindered by “brake fade,” which occurs when the brakes are overloaded while attempting to slow the massive vehicle. A sustained application of the brakes generates substantial heat that significantly hinders the brakes' stopping capability, thereby imperiling the truck driver and others nearby.

Accordingly, there is currently a need for a device that prevents brake fade in heavy-duty vehicles. The present invention addresses this need by providing a cooling system that circulates compressed air within each brake drum to cool internal brake components whenever the brake pedal is applied.

### SUMMARY OF THE INVENTION

The present invention relates to a brake cooling system for a heavy-duty truck comprising an air compressor mounted on a truck-cab chassis that is in fluid communication with a pressurized air reservoir. The reservoir outlet includes an automated solenoid valve that establishes select communication between the reservoir and an air distribution system. The air distribution system is formed of a network of compressed air tubes having arteries that each extend to a designated brake drum. Whenever the vehicle is traveling above a predetermined speed and the brake pedal is applied, a microprocessor opens the solenoid to deliver cooling air to each brake drum.

It is therefore an object of the present invention to provide a system that increases the efficiency and reliability of a truck's braking system.

It is therefore another object of the present invention to provide a truck-brake cooling system that automatically delivers cooling air to each brake drum whenever a brake pedal is depressed.

Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 is a plan view of a commercial truck with the cooling system according to present invention installed thereon.

FIG. 2 is an isolated view of the diffuser coupled with a brake-drum backplate.

FIG. 3 is a simplified schematic of the major components of the cooling system.

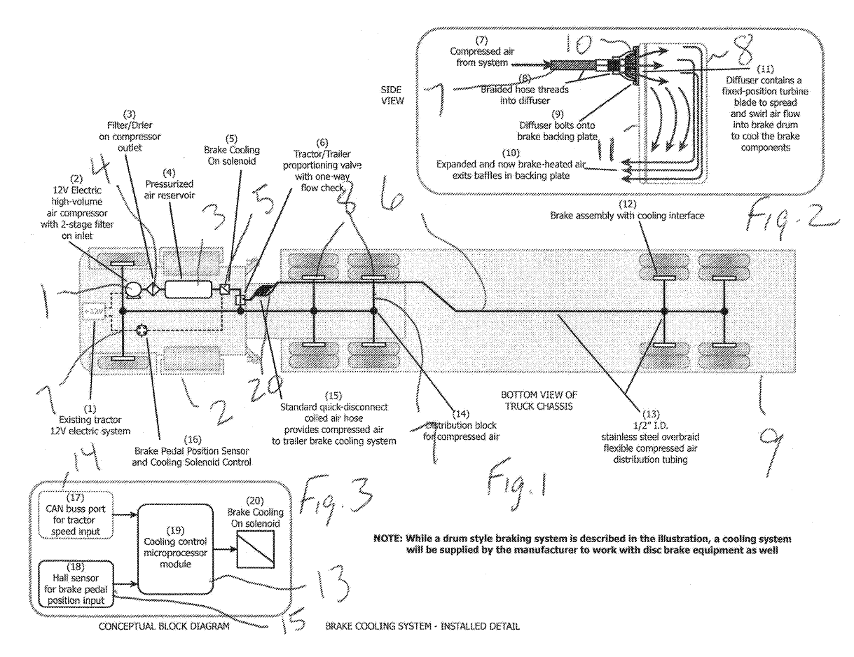

### DESCRIPTION OF THE PREFERRED EMBODIMENT

The present invention relates to brake cooling system for a heavy-duty truck comprising an air compressor 1 in fluid communication with a pressurized air reservoir 3 which are both mounted on a truck-cab chassis 2. The compressor outlet is coupled with a coalescing filter 4 having a blow-down valve and a desiccant drier to remove water, oil and particulates from the compressed air prior to entering the reservoir. The reservoir outlet includes an automated solenoid valve 5 that establishes select communication between the reservoir and an air distribution system 6. The air distribution system is formed of a network of compressed air tubes having arteries 7 that each extend to a designated brake drum 8. The cab includes a disconnect fitting 20 for coupling the distribution system of a designated trailer 9 with that of the cab. At a distal end of each artery is a diffuser 10 that is coupled with the brake drum backplate 11 to circulate compressed air within the drum interior to cool the internal brake components.

The solenoid is controlled by a microprocessor 13 that monitors the vehicle's CAN buss 14 to determine if the vehicle is traveling above a predetermined speed that warrants brake cooling. A Hall-effect sensor 15 proximal the brake pedal determines when the pedal has been depressed and signals the microprocessor accordingly. Therefore, whenever the vehicle is traveling above the predetermined speed and the brake pedal is applied, the microprocessor opens the solenoid to deliver cooling air to each brake drum.

The above-described device is not limited to the exact details of construction and enumeration of parts provided herein. Furthermore, the size, shape and materials of construction of the various components can be varied without departing from the spirit of the present invention.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

1) An air brake cooling system, comprising:
a reservoir of compressed air;
an air compressor to supply compressed air to the reservoir;
a brake to receive the compressed air from the reservoir to cool the brake.

2) An air brake cooling system as in claim 1, wherein the system includes an air distribution system having a network of compressed air tubes to connect to the reservoir to distribute the air to a plurality of designated drums.

3) An air brake cooling system as in claim 2 wherein the system includes a disconnect fitting for coupling the distribution system of a trailer.

4) An air brake cooling system as in claim 2, wherein a distal end of each air tube includes a diffuser coupled with a brake drum backplate to circulate the compressed air within a drum interior to cool an internal brake components.

5) An air brake cooling system as in claim 1, wherein an outlet of the compressor is coupled with a coalescing filter having a blow-down valve and a desiccant drier to remove water, oil and particulates from the compressor.

6) An air brake cooling system as in claim 2, or in an outlet of the reservoir t includes an solenoid valve to provide select communication between the reservoir and the distribution system.

7) An air brake cooling system as in claim 6, wherein the solenoid is controlled by a microprocessor to determine if the vehicle is traveling above a predetermined speed to activate brake cooling.

8) An air brake cooling system as in claim 1, wherein the system includes a Hall-effect sensor to determine when a brake pedal has been depressed to activate the brake cooling.
